(19) United States
(12) Patent Application Publication
(10) Pub. No.: US 2010/0225459 A1
(43) Pub. Date: Sep. 9, 2010

(54) BICYCLE DISPLAY LAMP STRUCTURE

(76) Inventors: Shuei-Yuan LEE, Taipei City (TW); Yuan-Liang Lee, Taipei City (TW)

Correspondence Address: Muncy, Geissler, Olds & Lowe, PLLC, 4000 Legato Road, Suite 310, FAIRFAX, VA, 22033, US

(21) Appl. No.: 12/550,139

(22) Filed: Aug. 28, 2009

(30) Foreign Application Priority Data
Mar. 3, 2009 (TW) 098203122

(51) Int. Cl. B62J 6/00

(52) U.S. Cl. 340/432

(57) ABSTRACT

A bicycle display lamp structure, including a casing, a circuit board disposed within the casing, a display body, a plurality of light source elements, and a clamping device located on the casing. In which the light source elements produce light sources, which are guided by the display body. The display body is provided with a light guiding area, the surface of which is provided with light reflecting portions of different words or patterns formed from an arrangement of concave points or grooved lines. Accordingly, the clamping device is used to clamp onto a bicycle, and the light sources projected by the light source elements proceed along the light guiding area of the display body and reflect outward from each of the reflecting portions, and further cause the words or patterns to be in a constantly lit or flashing state to achieve a cautionary function for rear oncoming vehicles.

### BACKGROUND OF THE INVENTION

(a) Field of the Invention

The present invention relates to a bicycle display lamp structure, and more particularly to a display lamp structure which can be fitted to a bicycle to form a cautionary function for rear oncoming vehicles.

(b) Description of the Prior Art

Apart from enabling a user to ride, the common bicycle does not have any additionally attached structures to enable producing light to serve as a caution for rear oncoming vehicles. Hence, in order to increase safety when riding a bicycle at night, some users install light reflectors at the rear of the bicycle. However, because of the poor display effectiveness of light reflectors, thus, companies have developed lamp accessories that can be additionally fitted to the bicycle, and such lamp accessories generally use light bulbs or light-emitting diodes as light sources for illumination to enable an exterior surface of the lamp form a bright surface, and thereby achieve a cautionary effect. However, such lamp structures can only form a light display, and are not able to display constantly lit or flashing words or patterns. In light of this, the inventor of the present invention, having accumulated years of experience in related arts, and through continuous research and experimentation, has endeavored to provide an improved bicycle display lamp structure which enables a display lamp to form constantly lit or flashing words or patterns, and thereby achieve a cautionary function for rear oncoming vehicles.

### SUMMARY OF THE INVENTION

The primary objective of the present invention lies in providing a bicycle display lamp structure, which can be fitted to the seat post below the bicycle seat or other locations to form constantly bright or flashing words or patterns, and further form a cautionary function for rear oncoming vehicles.

The aforementioned bicycle display lamp structure comprises a casing assembled from a front and rear cover, a circuit board disposed within the casing, a display body and a plurality of light source elements, as well as a clamping device located at a rear edge of the casing. In which the light source elements are used to produce and project light sources, and the display body receives and continues guidance of the light sources produced by the light source elements. The display body comprises a light guiding area of appropriate area, and the surface of the light guiding area is provided with light reflecting portions of different words or patterns formed from an arrangement of concave points or grooved lines. Accordingly, the bicycle display lamp structure is formed, whereby the clamping device is used to clamp onto the seat post below the bicycle seat or other locations, and an electronic circuit of the circuit board is used to control the light sources projected by the light source elements to proceed along the light guiding area of the display body and reflect outward from each of the reflecting portions, and further cause the words or patterns to be in a constantly lit or flashing state to achieve a cautionary function for rear oncoming vehicles.

The display body and the circuit board in the aforementioned bicycle display lamp structure are superpositioned, and the light source elements are mounted at two sides of the circuit board to enable the light sources to be projected onto the sides of the display body.

A backlit panel is disposed and clamped between the display body and the circuit board in the aforementioned bicycle display lamp structure, and the backlit panel is used to enable the words or patterns displayed by the display body to be more distinct.

The light source elements in the aforementioned bicycle display lamp structure can be different colored light-emitting diodes.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1A is an elevational view of the present invention.

FIG. 1B is an elevational view from another angle of the present invention.

FIG. 2 is an exploded elevational view of the present invention.

FIG. 3 is an exploded elevational view from another angle of the present invention.

FIG. 4 is an implementation view of a display body reflecting light sources according to the present invention.

FIG. 5 is an implementation view of the present invention in use.

FIG. 6 is an exploded elevational view of another assembly of an embodiment according to the present invention.

FIGS. 7, 8 are other implementation views of the present invention in use.

### DETAILED DESCRIPTION OF THE PREFERRED EMBODIMENTS

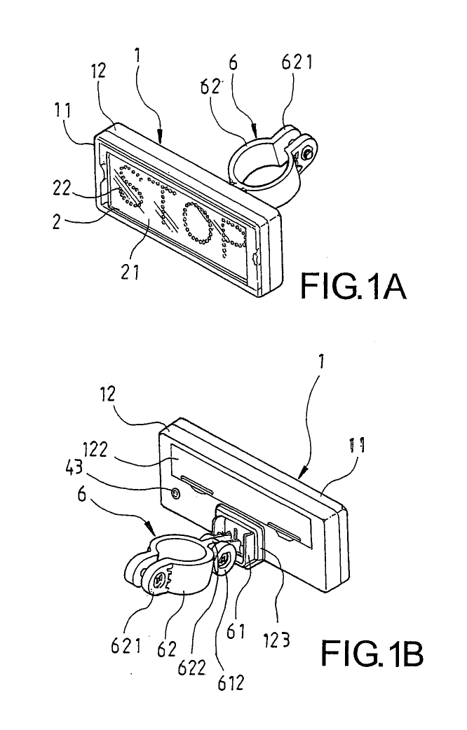

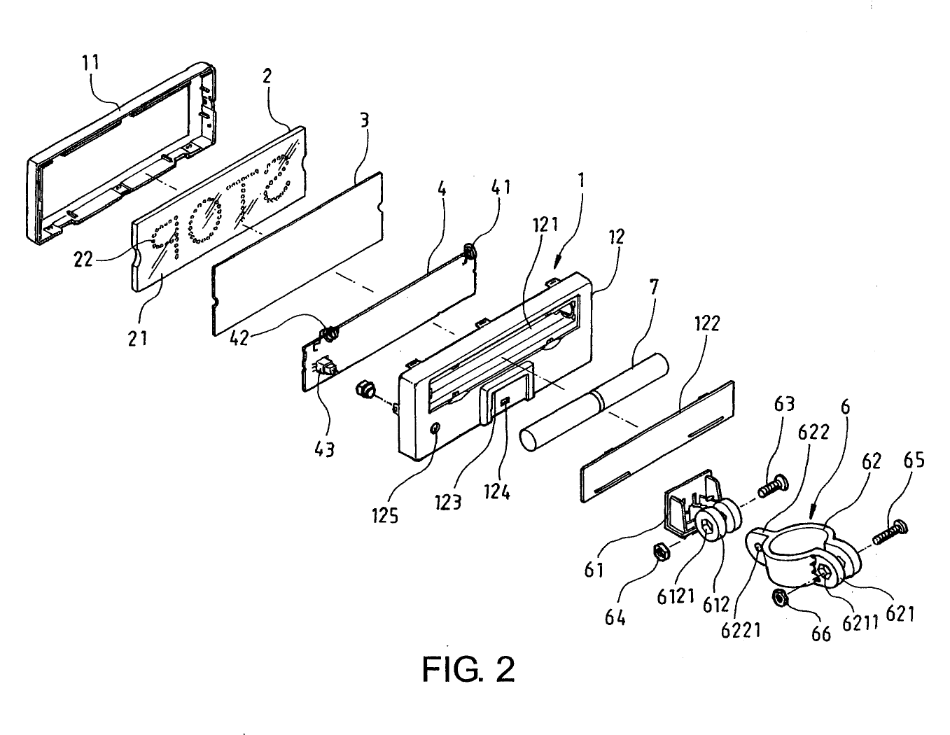

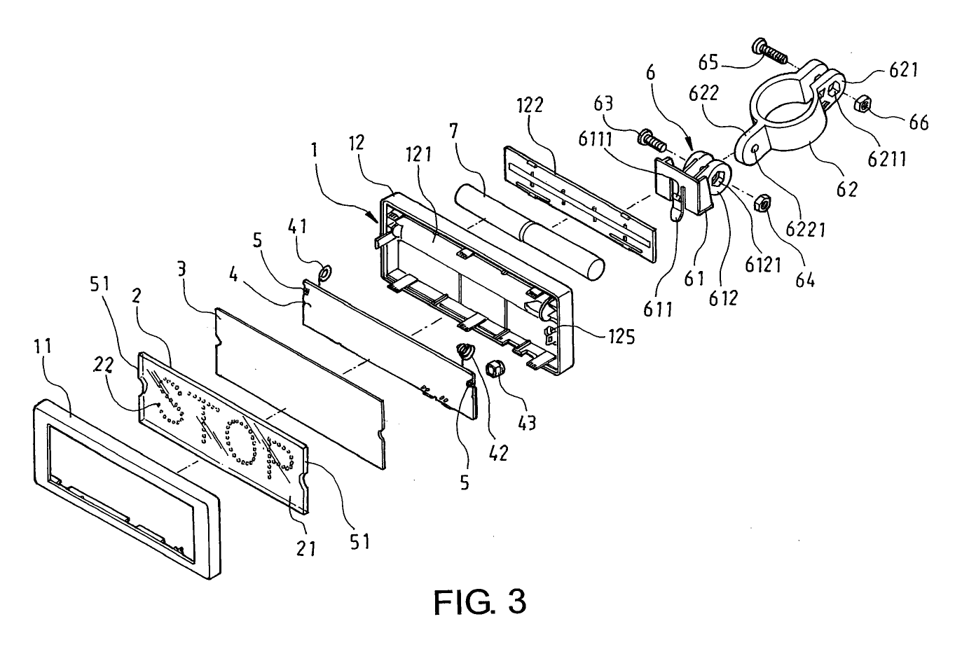

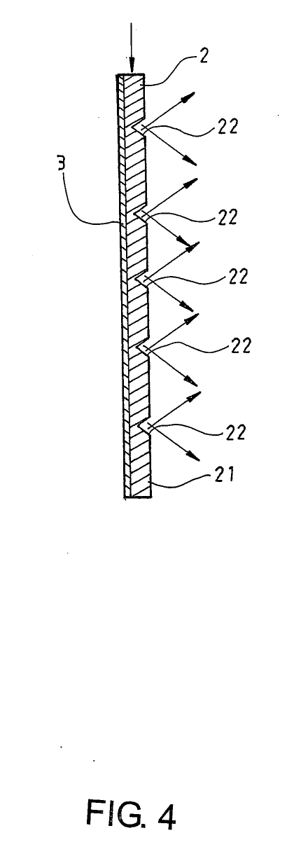

Referring together to FIG. 1A, FIG. 1B, which show elevational views of the present invention, and together with FIG. 2 and FIG. 3, which show exploded elevational views of the present invention, as depicted in the drawings, the present invention primarily comprises a casing 1, a display body 2, a backlit panel 3 and a circuit board 4 disposed and sequentially arranged within the casing 1, a plurality of light source elements 5 mounted on the circuit board 4, and a clamping device 6 located on an outer edge of the casing 1. In which the casing 1 comprises a front cover 11 generally assuming a frame shape and a box-shaped rear cover 12. The rear cover 12 is provided with a battery compartment 121 for holding batteries 7 and a cover 122 for covering the battery compartment 121. In addition, a slide groove 123 is provided below the battery compartment 121, a fastening hole 124 is defined in an inner edge of the slide groove 123, and a switch through hole 125 is defined to one side of the slide groove 123.

The display body 2 generally assumes a flat form made from light guiding material, and comprises a light guiding area 21 of appropriate area. Light reflecting portions 22 of different words or patterns formed from an arrangement of concave points or grooved lines are located on the surface of the light guiding area 21 (such as the word “STOP” depicted in the present embodiment). The light reflecting portions 22 are structured from concave points or grooved lines inwardly sunken to appropriate depths, and the concave points or grooved lines can be designed in a triangular form, diamond shaped, circular shaped or other geometrical shape able to reflect the light sources according to needs.

The backlit panel 3 is disposed and clamped between the display body 2 and the circuit board 4.

The circuit board 4 is provided with an electronic circuit, and a plurality of the light source elements 5 (which can be different colored light-emitting diodes) are mounted at two sides of the circuit board 4, with disposition of the light source elements 5 corresponding to light projection points 51 located at the sides of the display body 2. The rear side of the circuit board 4 is provided with contact spring pieces 41, 42, and the contact spring pieces 41, 42 are disposed within the battery compartment 121 of the rear cover 12, thereby enabling the positive, negative pole voltage of the batteries 7 to conduct current to the electronic circuit using the contact spring pieces 41, 42. Moreover, the circuit board 4 is provided with a switch 43, and the switch through hole 125 of the rear cover 12 of the casing 1 enables the switch 43 to be exposed therethrough.

The clamping device 6 comprises a base 61 and a clamping member 62, and a spring piece 611 is located in a suspended form extending downward from a front edge of the base 61. A protruding rib 6111 is located on a surface of the spring piece 611, symmetrical, circular shaft shaped fixing pieces 612 are located on a rear edge of the base 61, and the fixing pieces 612 are provided with fixing holes 6121. The clamping member 62 is a ring body, one end of which is configured as an opening locking portion 621, and the locking portion 621 is provided with fixing holes 6211. A lug 622 is located on another end of the clamping member 62, and the lug 622 is provided with a fixing hole 6221, thereby enabling the lug 622 to be fitted to the fixing pieces 612 of the base 61 using a screw 63 which passes through the fixing holes 6121, 6221, after which a screw nut 64 is locked tight thereon. Accordingly, the base 61 can be angular adjusted using up and down swinging movements about the lug 622 as a supporting point.

The assembly of the foregoing components enables the clamping member 62 of the clamping device 6 to be disposed and clamped onto the seat post below the seat of a bicycle or other locations using locking of the screw 65 and the screw nut 66 in the fixing holes 6211 of the locking portion 621 to structurally fix the clamping member 62, and then the slide groove 123 of the rear cover 12 of the casing 1 is insertedly disposed on the base 61 of the clamping device 6, with the protruding rib 6111 being used to clasp into the fastening hole 124 and secure the casing 1, thereby forming the bicycle display lamp structure. After the switch 43 is used to activate the power source, the electronic circuit of the circuit board 4 is used to control lighting of the light source elements 5 to produce light sources. Then the light sources projected by the light source elements 5 proceed along the light guiding area 21 from the light projection points 51 at the sides of the display body 2 and reflected outward from each of the reflecting portions 22, thereby forming constantly lit or flashing words or patterns to achieve a cautionary function for rear oncoming vehicles.

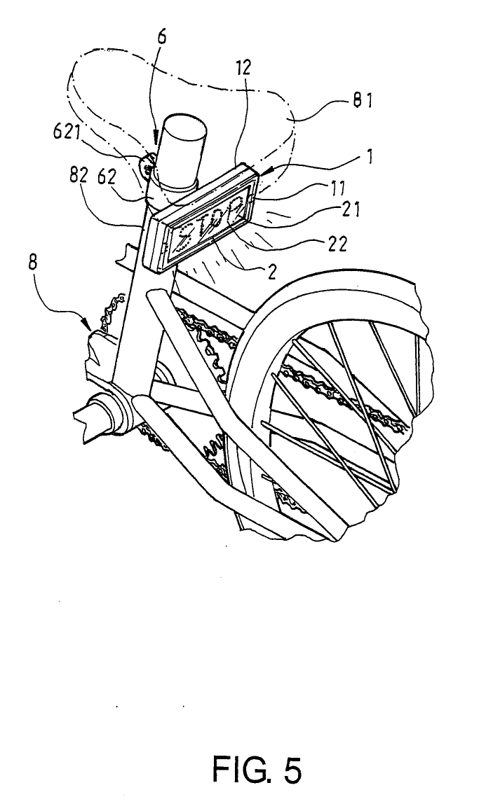

Referring to FIG. 4, which shows the display body 2 of the present invention, wherein the surface of the light guiding area 21 is provided with the reflecting portions 22 of different words or patterns formed by using an arrangement of concave points or grooved lines. Accordingly, after light sources project light onto the light guiding area 21, then the light sources are able to proceed along the light guiding area 21 and be reflected outward at various angles from each of the reflecting portions 22, thereby forming constantly lit or flashing words or patterns. Moreover, the backlit panel 3 located at the rear of the display body 2 enables the words or patterns displayed by the display body 2 to be more distinct.

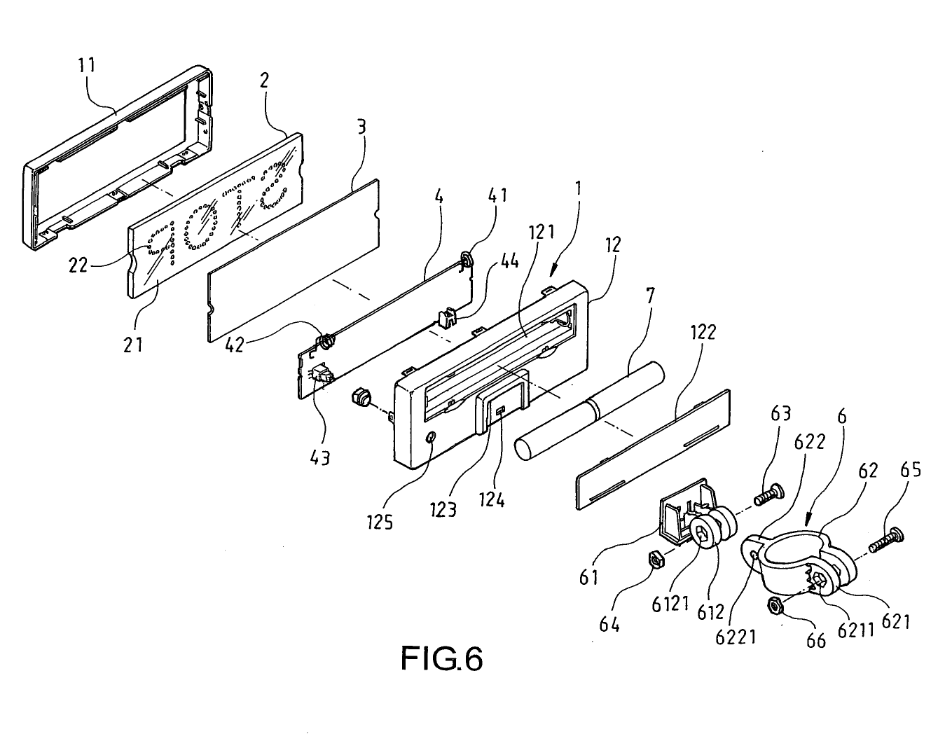

Referring to FIG. 5, which shows an implementation view of the present invention in use, and together with FIG. 3, as depicted in the drawings, when using the present invention, the clamping member 62 of the clamping device 6 is used to dispose and clamp onto a seat post 82 below a seat 81 of a bicycle 8 or other locations, and locking of the screw 65 and the screw nut 66 in the fixing holes 6211 of the locking portion 621 is used to structurally fix the clamping member 62, thereby enabling the base 61 to be angular adjusted using up and down swinging movements about the lug 622 as a supporting point to adjust the casing 1 to the preferred display angle. After activating the power source, the electronic circuit of the circuit board is used to control lighting of the light source elements 5 to produce light sources, and the light sources projected by the light source elements 5 are further caused to proceed along the light guiding area 21 from the sides of the display body 2, after which the light sources are reflected outward from each of the reflecting portions 22, thereby forming constantly lit or flashing words or patterns to achieve a cautionary function for rear oncoming vehicles, and thus improve riding safety for cyclists.

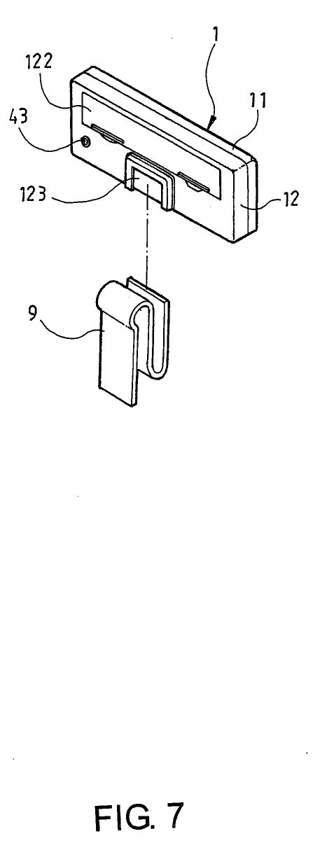

Referring to FIG. 6, apart from using the batteries 7 to provide a power source, the present invention can also use a power socket 44 mounted on the circuit board 4 to enable connection to a generator which rotates along with rotation of the wheel, thereby charging the batteries 7 as the bicycle continues to move forward, thus eliminating the need to frequently replace the batteries.

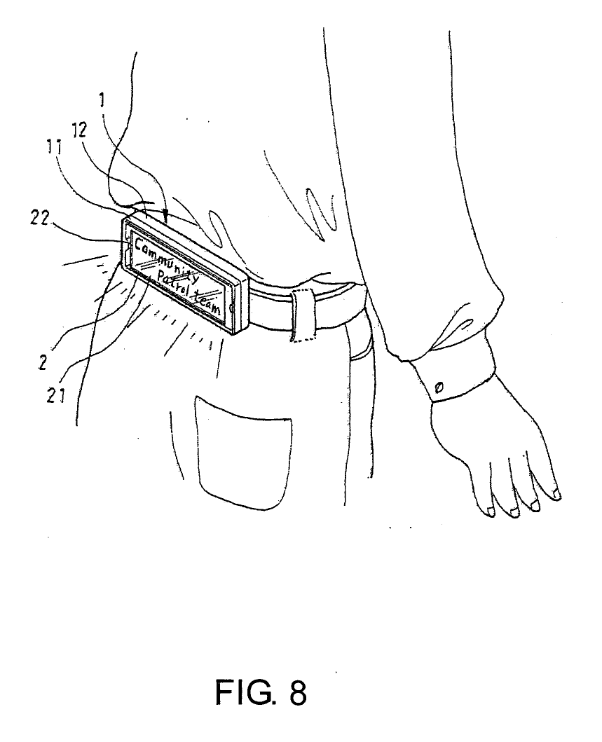

Referring together to FIG. 7 and FIG. 8, which show other implementation views of the present invention in use, and as depicted in the drawings, the display body 2 of the present invention is be provided with the reflecting portions 22 of different words or patterns formed by using an arrangement of grooved lines defined on the surface of the light guiding area 21, such as the sample words “Community Patrol Team” depicted on the display body 2 in FIG. 8. Moreover, the casing 1 can also use the slide groove 123 defined in the rear cover 12 to insertedly dispose on a clamping end of a clamping member 9 generally assuming a N shape, and another clamping end of the clamping member 9 is used to dispose and clamp onto the belt of a patrol team member for use by the patrol team member when patrolling, thereby intensifying a reference point display of the patrol team member when moving around, and forming another cautionary effect configuration. In conclusion, the present invention uses light source elements, and a display body having reflecting portions formed from an arrangement of words or patterns positioned relative to the light source elements, the reflecting portions of the display body being used to reflect the light sources. Accordingly forming a bicycle display lamp structure which can be installed on the seat post below the bicycle seat or other location to enable the display of constantly lit or flashing words or patterns, and further achieve a cautionary function for rear oncoming vehicles. Hence, the present invention provides a practical design, and is surely a novel invention. Hence, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A bicycle display lamp structure, comprising:
a casing, structured from a frame-shaped front cover and a box-shaped rear cover, and the rear cover is provided with a slide groove;
a display body, the display body assumes a flat form and is made from light guiding material, the display body comprises a light guiding area of appropriate area, and the surface of the light guiding area is provided with light reflecting portions of different words or patterns formed from an arrangement of concave points or grooved lines;
a circuit board, an electronic circuit is mounted on the circuit board, a plurality of light source elements are located at two sides of a front edge of the circuit board, and light projection points are disposed at the sides of the display body corresponding to the light source elements;
a clamping device, the clamping device comprises a base insertedly disposed in the slide groove of the rear cover of the casing, and a clamping member which is disposed and clamped onto the seat post below the bicycle seat or other position;
whereby the assembly of the components forms the bicycle display lamp, and the electronic circuit of the circuit board is used to control lighting of the light source elements to produce light sources, and the light sources projected by the light source elements are further caused to proceed along the light guiding area from the sides of the display body, after which the light sources are reflected outward from each of the reflecting portions, thereby forming constantly lit or flashing words or patterns to achieve a cautionary function for rear oncoming vehicles.

2. The bicycle display lamp structure according to claim 1, wherein a backlit panel is disposed and clamped between the display body and the circuit board, thereby enabling the words or patterns displayed by the display body to be more distinct.

3. The bicycle display lamp structure according to claim 1, wherein the concave points or grooved lines of the reflecting portions of the display body are designed in a triangular form, diamond shaped, circular shaped or other geometrical shape able to reflect the light sources according to needs.

4. The bicycle display lamp structure according to claim 1, wherein the light source elements mounted on the circuit board are different colored light-emitting diodes.

5. The bicycle display lamp structure according to claim 1, wherein a power socket is mounted on the circuit board to enable connection to a generator which rotates along with rotation of the wheel, thereby charging batteries as the bicycle continues to move forward.
